(19) United States
(12) Patent Application Publication
(10) Pub. No.: US 2024/0160482 A1
(43) Pub. Date: May 16, 2024

(54) DYNAMIC AND CASCADING RESOURCE ALLOCATION

(71) Applicant: INTERNATIONAL BUSINESS MACHINES CORPORATION, ARMONK, NY (US)

(72) Inventors: Peng Hui Jiang, Beijing (CN); Wei Wu, Beijing (CN); Xin Peng Liu, Beijing (CN); Xiao Ling Chen, Beijing (CN); Yue Wang, Beijing (CN); Jun Su, Beijing (CN)

(21) Appl. No.: 18/054,923

(22) Filed: Nov. 14, 2022

(51) Int. Cl. G06F 9/50

(52) U.S. Cl. CPC G06F 9/5027

(57) ABSTRACT

A method, computer system, and a computer program product is provided for dynamic allocation of resources. A database access pattern is determined by analyzing and monitoring traffic pattern between a pool of resources and a plurality of clients. The relationship between each of the resources is also determined. Access is enabled to a plurality of resources based on the database access and resource relationships, so that the plurality of resources can be accessed but not allocated until processing a request. A consumption model is generated that predicts resource need during a processing request based on the resource relationships, traffic pattern and resources availability. Upon receipt of a subsequent request for processing, consumption model is used to predict resource needs and to dynamically allocate, re-allocate and release the plurality of resources in a cascading manner until completion of subsequent processing request.

### BACKGROUND

The present invention relates generally to the field of data management and more particularly to techniques for allocating resources dynamically.

Many businesses have found it to be more cost effective to purchase computer resources as part of a service. Using a service provider often involves the computer resources that may be purchased to reside remotely. These services may also involve remote program execution, request processing by virtual machines and remote data storage. Many customer needs may be provided in form of software containers. A container may be a software package that also includes everything the software requires in order to run a particular program on a particular platform. This includes the executable program as well as system tools, libraries, and settings.

Containers may not be installed like traditional software programs so as to allows them to be isolated from one another and the operating system itself. Customers, also called tenants, may be responsible for selecting a container size suitable for their workloads which they can change to leverage cloud's elasticity. However, automating this task may be daunting for most tenants and service providers because predicting workloads and resources to process them can be complex and challenging as the resource requirements can vary significantly within minutes to hours.

### SUMMARY

Embodiments of the present invention disclose a method, computer system, and a computer program product for dynamic allocation of resources. In one embodiment, a database access pattern is determined by analyzing and monitoring traffic pattern between a pool of resources and a plurality of clients during performance of at least one task, wherein the traffic pattern includes accessing at least one database. The relationship between each of the resources in the pool is also determined. Access is enabled to a plurality of resources in the pool based on the database access and resource relationships, so as to enable the plurality of resources to become accessible for use without being allocated unless there is a processing request. A consumption model is then generated that can predict resource need for a processing request based on resource relationships, traffic pattern and resources availability. Upon receipt of a subsequent request for processing, this consumption model is used to predict resource needs and to dynamically allocate, reallocate and release the plurality of resources in a cascading manner until the subsequent request for processing is completed.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for providing a dynamic resource allocation technique according to one embodiment;

FIG. 3 provides a block diagram of a pool architecture according to an embodiment;

FIG. 4 is a table providing an example of a database index according to the embodiment of FIG. 2;

FIG. 5 provides a block diagram of a Client Traffic Analyzer according to one embodiment;

FIG. 6 provides a block diagram showing a Resource Relation Analyzer accessing the same databases according to one embodiment;

FIG. 7 provides a block diagram showing a Resource Relation Analyzer accessing different databases according to one embodiment;

FIG. 8 is a block diagram illustration of a Multi Resource Usage Predictor according to one embodiment; and

FIG. 9 is a block diagram of a Multi-Resource Manager as per one embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

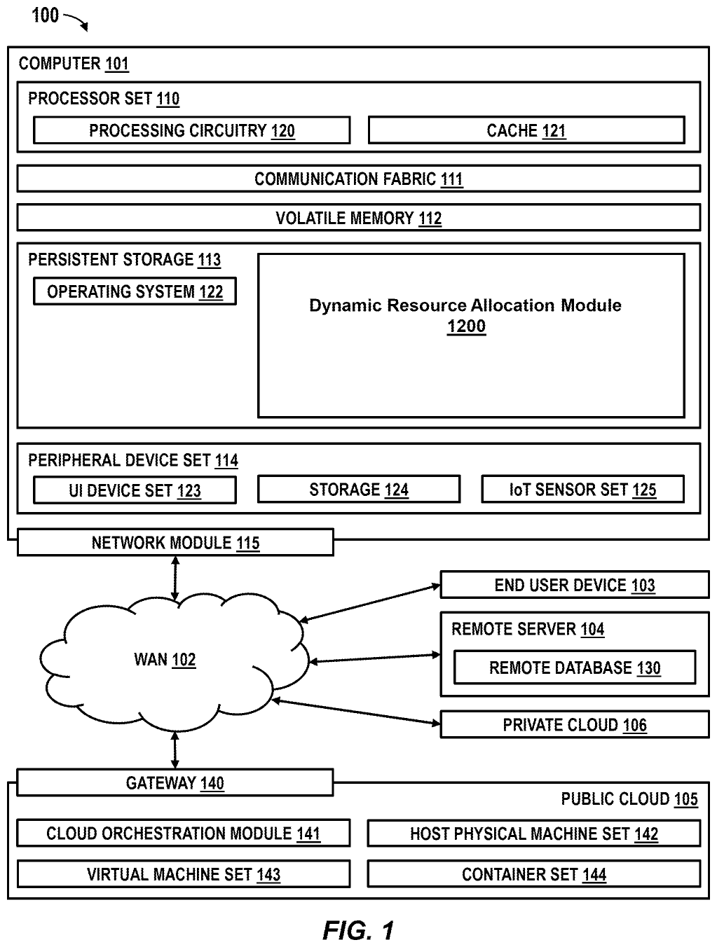

FIG. 1 provides a block diagram of a computing environment 100. The computing environment 100 contains an example of an environment for the execution of at least some of the computer code involved in performing the inventive methods, such as code change differentiator which is capable of providing a dynamic resource allocation module 1200. In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

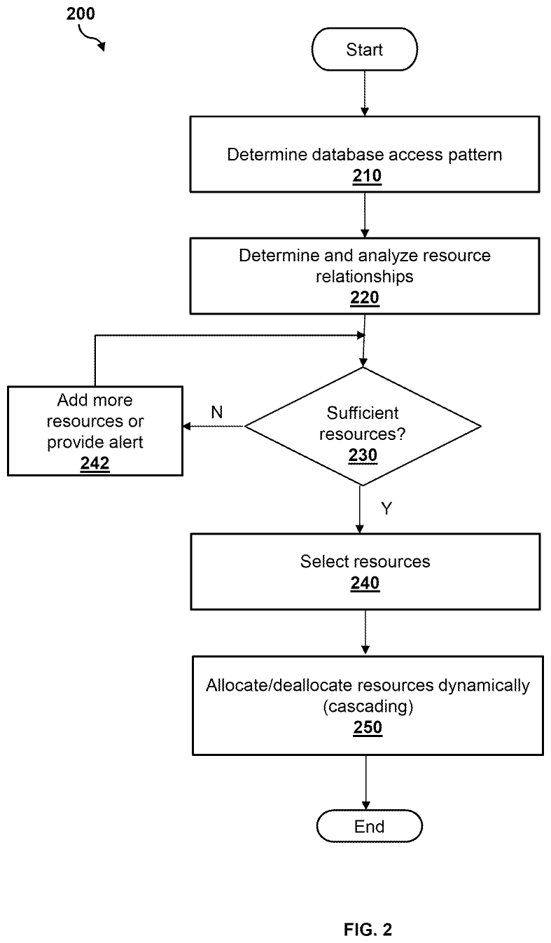

Database-as-a-Service (DaaS) platforms today support the abstraction of a resource container that guarantees a fixed number of resources. Customers, sometimes referred to as tenants are responsible for selecting a container size suitable for their workloads, which they can change to leverage the cloud's elasticity. However, automating this task is daunting for most tenants since estimating resource demands for arbitrary SQL workloads in DBaaS is complex and challenging. In addition, workloads and resource requirements can vary significantly within minutes to hours, and container sizes vary by orders of magnitude both in the amount of resources as well as monetary cost. Consequently, it may become necessary to allocate database resources in the proper time with the proper amount, including connection pool, Buffer Pool, Queue, etc, especially during cascade situation or across databases. The process 200 of FIG. 2 provides for a technique to dynamically provide a solution to these issues.

FIG. 2 provides a flowchart depiction of a process 200 that provides a dynamic and cascading resource allocation technique. This allows for management of resource pools in a database as well. The process 200 has a plurality of steps as provided below.

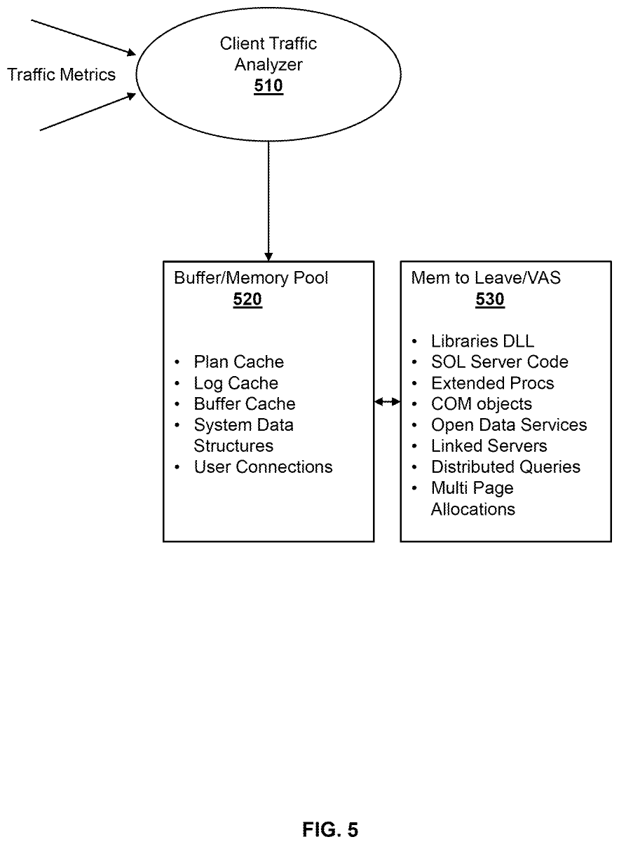

In Step 210, database access pattern may be established. This may involve collecting and analyzing traffic patterns. In one embodiment, the traffic patterns are monitored for both external and internal clients. In addition, a Client Traffic Monitor module may be used to collect database traffic from these external and internal clients. This may include periodically extracting and analyzing transactional traffic such as by using a Client Traffic Analyzer (See FIG. 5) module so as to build one or more database access patterns. This process may also include accepting database access traffic and processing access requests according to different workload patterns.

In one embodiment, the traffic can be monitored and controlled. In one embodiment, a Traffic Control Monitor (not illustrated) may be used as a part of the Client Traffic Analyzer to analyze and collect client traffic data from internal client and external client against database. A variety of means can be used to accomplish this task. Some examples are server-based agent software, in-line network collectors and out-of-band network collectors.

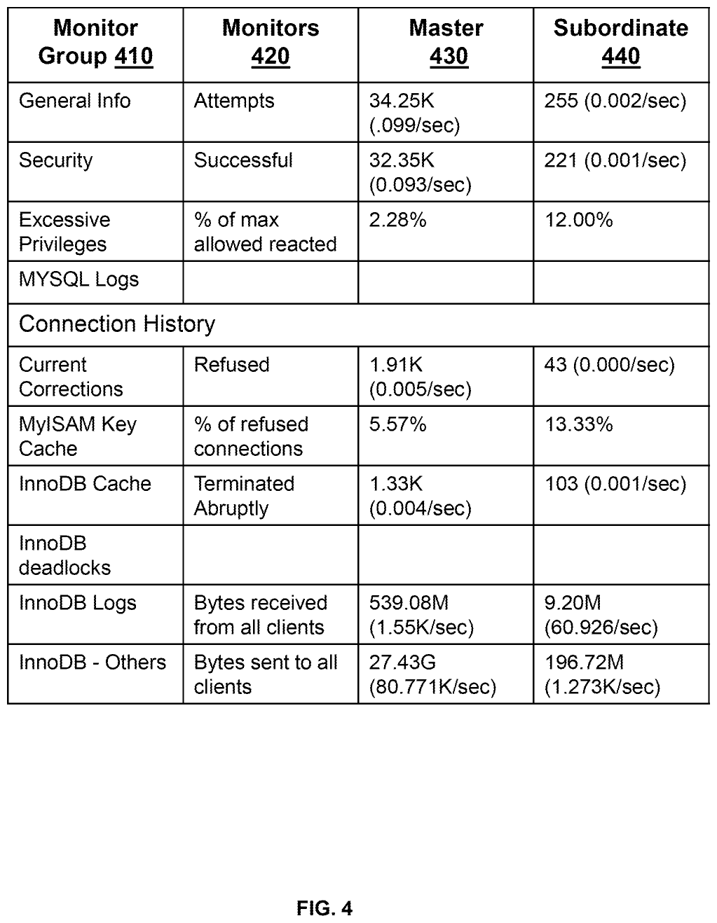

In one embodiment, count accesses to database and database indexes are monitored and analyzed both in a disk-block and individual terms. This can be shown as an example in FIG. 4. FIG. 4 provides a table that has been accumulated to ease understanding but other scenarios and alternate embodiments provide different tables as can be appreciated by those skilled in the art. In FIG. 4, there are “Monitored Groups” 410 that provide information on a range of different monitored options from security to different logs and connection histories. This measures data such as number of attempts, percentage of successful/refused attempts and such as provided by column 420 and associated Master (430) and Subordinate (440) numerical data. In the example of FIG. 4, it can be seen how this and alternate methods can keep track of the total number of accessed databases in each transaction as well as their calling chain. The count calls to user-defined functions along with the total time spent (in each one).

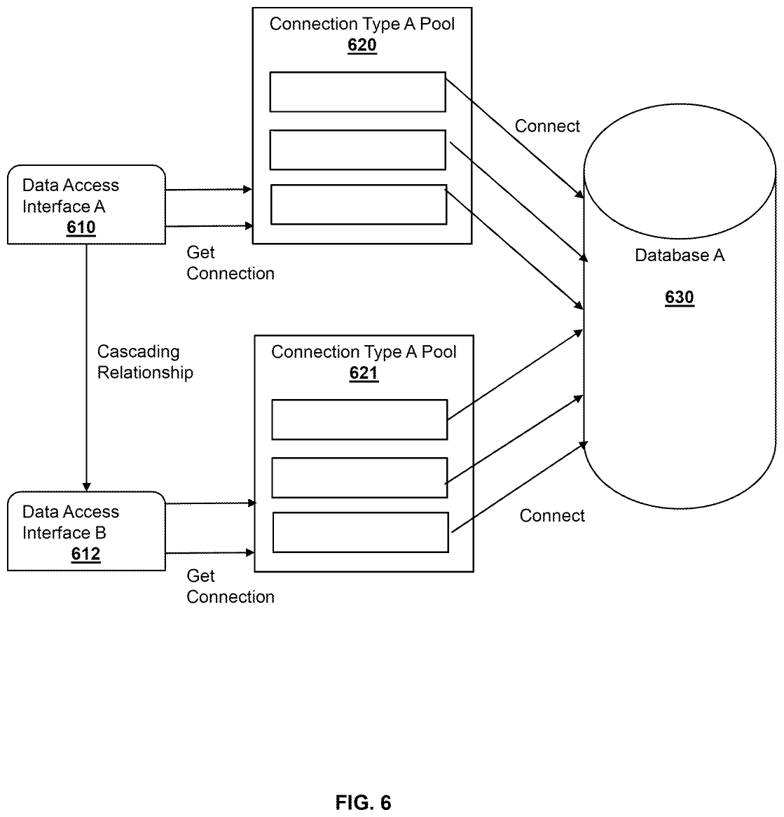

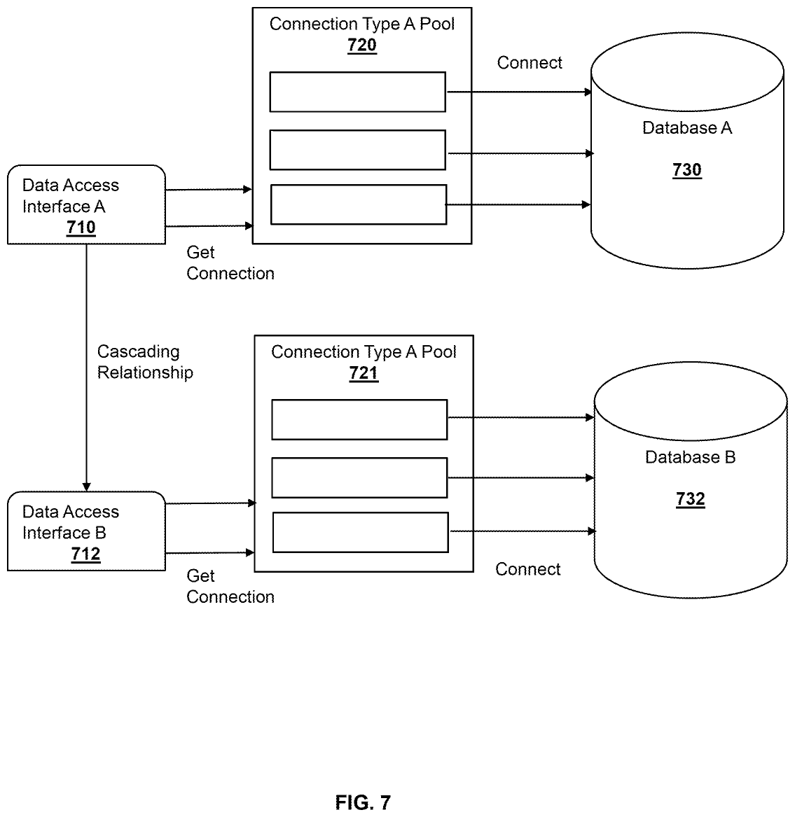

Referring back to FIG. 2, in Step 220, workload intricacies may be captured. This may involve determining and analyzing resource relationships. In one embodiment, a Database Resource Analyzer module (shown in more details in FIGS. 6 and 7) may be used to capture and analyze some of the processes and resource relationships such as some of the ones provided below:
identifying relationships of same resources among components within a database;
identifying relationships of same resources among components across one or more databases;
identifying relationships of different resources among components within one or more databases; and
identifying relationships of different resources among components across at least one database.

In Step 230, it is determined whether the resources in the pool may be sufficient for each request processing. In one embodiment, this can be performed by providing a consumption model by using a Multi Resource Usage Predictor module. Using this module may establish a resource consumption model to predict resource consumption that will in turn allow for determining and selecting whether the existing resource pool will be sufficient for each request processing.

In Step 240, when it has been determined that a resource pool may be sufficient for request processing, existing resources may be selected and fetched from the existing resource pool. Alternatively, as provided in step 242, when the pool may not be sufficient, additional resources can be added or alternatively an alert can be provided.

In Step 250, resources will be allocated (new or existing resources) in a cascading manner. In one embodiment, a Multi Resource Manger module allocates these new resources and adds them when appropriate into the resource pool. In one embodiment, this includes determining when to allocate new resources in a cascading manner. It also includes releasing resources dynamically when the task has been completed.

In one embodiment, the methodology of FIG. 2 provides an intelligent technique to dynamically allocate a resource pool in one or more databases and across databases in a cascading way. This will resolve the limitations associated with resource usage which can't be changed in time in a cloud platform. This in turn allows for the handling of connection request issues which may be hard to be manually administrator, and which may have scenario changes frequently in a cloud platform. In this way, this will also resolve the issue of balancing resource pools in a cloud platform.

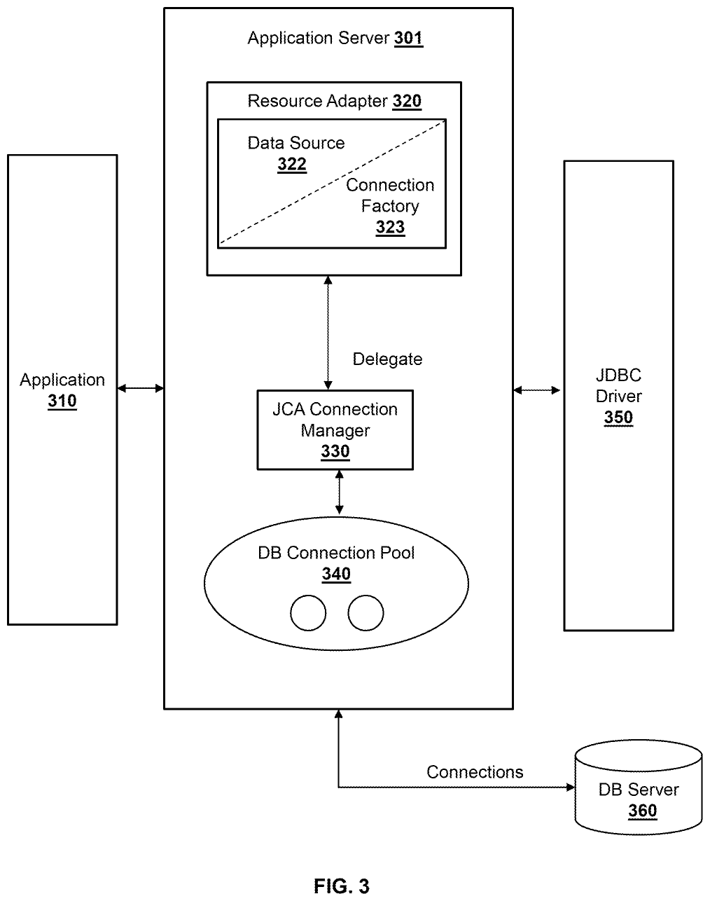

FIG. 3 provides a block diagram of a pool architecture. FIG. 3 may be an example for an embodiment that helps provide understanding to the techniques discussed in FIG. 2. In an alternate embodiment, other connection pool architectures may be designed as can be appreciated by those skilled in the art.

In one embodiment, an application 310 acquires a data resource or a connection factory object 322/323 from a resource adapter 320 (residing in an application server 301 in communication with a driver 350). The data source/connection factory 322/323 delegates the connection allocation request to a connection manager 330. The connection manager 330 retrieves a free connection from the database (DB) connection pool 340 or creates a new one if none may be available. The retrieved or created connection may then be returned to the application via the database server 360.

FIG. 5 provides a block diagram of a Client Traffic Analyzer 510. Traffic metrics may be received from one or more clients. This may then be analyzed by the Client Traffic Analyzer 510. Aggregated database access metrics may be generated based on resource usage pattern(s). This can include maximum/minimum, averages and medians, sums and counts, percentile ranks etc. In addition, an aggregate of accessed resources within and across the databases are generated. These can include buffer pool, connection pool, cache, lock, hash index etc. An example is shown as the “Buffer Pool/Memory Pool” 520 and “Memory to Leave” 530. An associated sample code can be:

```
{
        {metrics_uuid: String
        metrics_name: String
        input: {
    traffic_metrics_1: Type
          traffic_metrics _2: Type
          ...
      traffic_ metrics _n: Type
}
output: {
    buffer_pool_1: Type
    connection_pool_2: Type
      ...
      hash_index_n: Type
}
related_database:{
type: String
databases_: {
    database_metadata: String
  }
}
}
```

FIGS. 6 and 7 provide different examples of how database Resource Relation Analyzer can collect and analyze real time information as provided in the flowchart of FIG. 2. The collection and analysis of real time events can include buffer pool, connection pool, hash index lock etc. Databases can be associated to resources in a number of ways as can be appreciated by those skilled in the art. In one embodiment, it may be possible to even have a module (a resource relationship analyzer module not illustrated) that may associate database resource access events with client traffic. In either case, relationship access can be deduced including parallel, sequential, and cascading relationships as discussed earlier. In one embodiment, entries in a knowledge base can be generated for resource allocation and usage. This can be accomplished for the same type of resource in one database as shown in FIG. 6 or as different type of resource in on the same database as shown in FIG. 7. It could also involve the same type or different type of resources across databases.

In FIG. 6, the same type of resource may be provided on the same database 630. One or more data access interfaces (A and B denoted by numerals 610 and 612) may be enabled to connect to the same type of connection pools (provided as two pools 620 and 621). Database Resource Access model detects when there may be a good chance to allocate the resource for cascading requests.

In FIG. 7, a scenario has been provided where the same type of resource may be connected to different databases A and B denoted by numerals 730, 732. Data access interfaces 710 and 720 may be enabled to connect to the same type of pool 720/721. In one embodiment, a module may be provided (not illustrated) that can detect database resource availability (Database Resource module) when there may be a good chance to allocate resources for cascading requests.

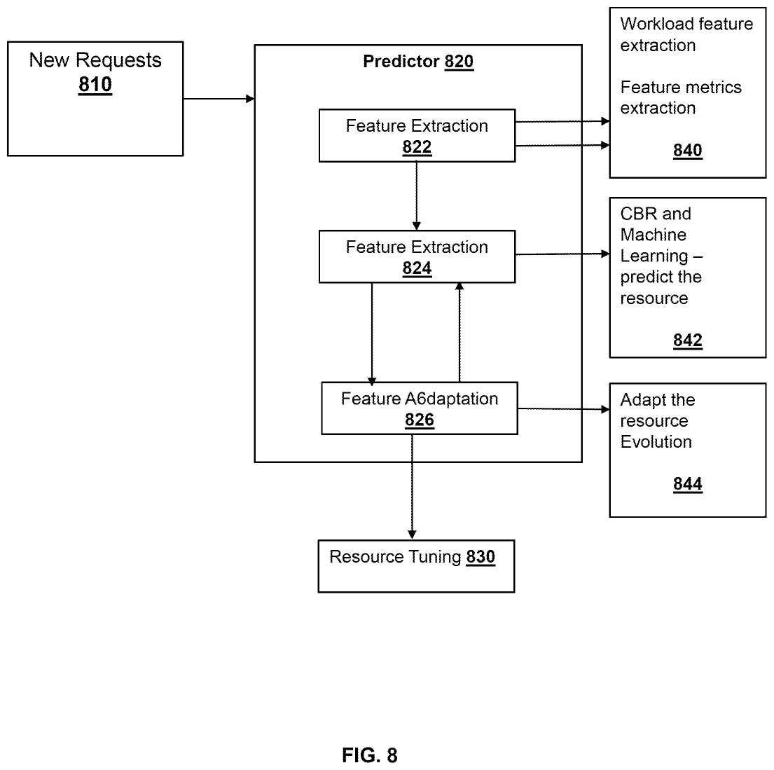

FIG. 8 provides a block diagram illustration of a Multi Resource Usage Predictor (hereinafter the Predictor) 820. The Predictor collects and analyzes workload traffic and predict the trend of resource usage. As illustrated in FIG. 8, New requests 810 may be received by the Predictor 820. A number of different features 822/824 may be extracted to provide a number of outputs as shown at 840-844. The Predictor 820 also provides resource adaption 826 by communicating with one or more feature extractors 822/824. Besides the outputs provided 840-844, a resource tuning step 830 may also be provided using the information obtained.

Now looking at the provided output of the Predictor 820, the first output provides an estimated workload and determine some characteristics and metrics using the feature extractions as seen at 840. Some examples of such metrics may be provided below but many others can be provided in alternate embodiments:
Expected arrival rate of queries
running time of each query
structural and periodic patterns
workload shifts
the next transaction or query
memory usage of each query

The predictor can also provide a case based reasoning (CBR) which can also be used for machine learning and by Artificial Intelligence (AI) modules and agents as seen at 842. This will allow new cases to be adapted without requiring retraining of data.

In one embodiment, CBR in turn can use the information to check if an identical training pool allocation case exists. If one can be found, an accompanying solution to the case can be returned. If no identical case can be found, then the CBR will search for training cases, having components that may be similar to those of any new cases (similar to database access model). In one embodiment, the cases may be represented by graphs. In such a case the search involves looking for subgraphs that may be similar to the one of a new request/case.

In one embodiment, if the CBR tries to combine the solutions of the neighboring training cases to propose a solution for the new case. In this case, if compatibilities arise with the individual solutions, then a backtracking tool will search for other solutions, as appropriate and necessary.

Another output provided has to do with Resource Adaptation as shown at 844. This aims at determining the execution of order of queries. Again, an AI module or a machine learning based component can provide a reasoning-based structure.

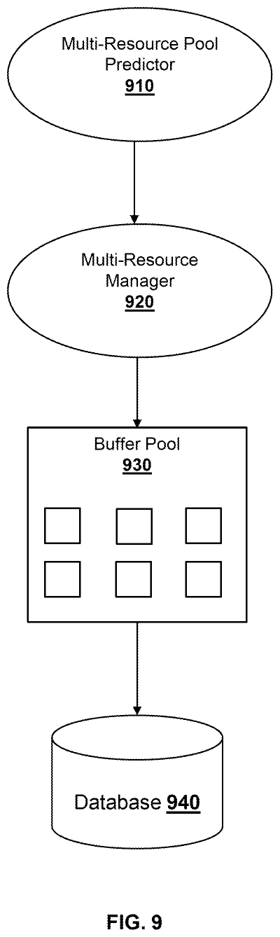

FIG. 9 provides a block diagram of a Multi-Resource Manager as per one embodiment. The multi-resource manager 920, will allocate resources and release resources dynamically. The multi-resource manager 920 receives input from the Multi-Resource Pool Predictor 910 and will analyze the Buffer pool 930 and determine dynamic changes. The multi-resource manager 920 will decide whether the existing resource pool may be enough for request processing. For such a case, it fetches existing resource from the resource pool. It also allocates new resources and add them into resource pool and when to allocate these new resources in a cascaded manner. It will also respond to the request from Multi-Resource Pool Predictor 910 to allocate resources. It may also be enabled to scan the usage of resource pool and prune the resource if the idle time may be larger than the defined threshold. This information may be provided to the database 940.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing dynamic resource allocation in a computing environment, comprising:
determining a database access pattern by analyzing and monitoring traffic pattern between a pool of resources and a plurality of clients during a performance of at least one task, wherein said traffic pattern includes accessing at least one database;
determining any relationships between each of said resources;
enabling an access to a plurality of said resources in said pool based on said database access pattern and said resource relationship, wherein said plurality of resources in said pool can be accessed but do not have to be allocated until a processing of a request;
generating a consumption model to predict resource needs based on said resource relationships, a traffic pattern and an availability of said plurality of resources; and
upon receiving of a subsequent request for processing, using said consumption model to predict any resource needs so as to dynamically allocate, reallocate and release said plurality of resources in a cascading manner until a completion of said subsequent request.

2. The method of claim 1, wherein upon determining that said plurality of resources are not sufficient, at least one additional resource is added and enabled from said resource pool.

3. The method of claim 2, wherein other resources are enabled and added that have not been part of said resource pool and when no resource availability is found, an alert is generated so that a processing request cannot be performed due to resource availability.

4. The method of claim 1, wherein a plurality of databases is used by said computing environment.

5. The method of claim 4, wherein analyzing the relationships between said resources and any internal and external clients includes at least one of identifying the relationships of same resources among components within a database or identifying the relationships of same resources among components across one or more databases.

6. The method of claim 4, wherein analyzing the relationships between said resources and any internal and external clients includes at least one of identifying the relationships of different resources among components within said one or more databases, and identifying the relationships of different resources among components across at least one of said one or more databases.

7. The method of claim 1, wherein said consumption model is used by a Multi-Resource Pool Predictor to allocate and reallocate resources, wherein said Multi-Resource Pool Predictor is enabled to scan a usage of said Multi-Resource Pool Predictor and remove at least one of said resources when an idle time is larger than a defined threshold.

8. The method of claim 7, wherein said Multi-Resource Pool Predictor uses said consumption model to provide an estimated request for completing processing and a plurality of related metrics for said request processing.

9. The method of claim 8, wherein said metrics include at least one of: an expected arrival rate of at least one query and a running time of each query.

10. The method of claim 9, wherein metrics also include a next transaction of a new query and a memory usage associated with each of said queries.

11. The method of claim 8, wherein said metrics can include a structural and a periodic shift in a workload or a prediction of the workload shift associated with a processing of said request.

12. A computer system for providing dynamic resource allocation, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps:
determining a database access pattern by analyzing and monitoring traffic pattern between a pool of resources and a plurality of clients during a performance of at least one task, wherein said traffic pattern includes accessing at least one database;
determining any relationships between each of said resources;
enabling an access to a plurality of said resources in said pool based on said database access pattern and said resource relationship, wherein said plurality of resources in said pool can be accessed but do not have to be allocated until a processing of a request;
generating a consumption model to predict resource needs based on said resource relationships, a traffic pattern and an availability of said plurality of resources; and
upon receiving of a subsequent request for processing, using said consumption model to predict any resource needs so as to dynamically allocate, reallocate and release said plurality of resources in a cascading manner until a completion of said subsequent request.

13. The computer system of claim 12, wherein upon determining that said plurality of resources are not sufficient, at least one additional resource is added and enabled from said resource pool.

14. The computer system of claim 13, wherein other resources are enabled and added that have not been part of said resource pool and when no resource availability is found, an alert is generated so that a processing request cannot be performed due to resource availability.

15. The computer system of claim 12, wherein a plurality of databases is used by said computing environment.

16. The computer system of claim 12, wherein said consumption model is used by a Multi-Resource Pool Predictor to allocate and reallocate resources, wherein said Multi-Resource Pool Predictor is enabled to scan a usage of said Multi-Resource Pool Predictor and remove at least one of said resources when an idle time is larger than a defined threshold.

17. A computer program product for providing dynamically resource allocation, comprising:
one or more computer-readable storage medium and program instructions stored on at least one of a one or more tangible storage mediums, the program instructions executable by a processor, the program instructions comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps comprising:
determining a database access pattern by analyzing and monitoring traffic pattern between a pool of resources and a plurality of clients during a performance of at least one task, wherein said traffic pattern includes accessing at least one database;
determining any relationships between each of said resources;
enabling an access to a plurality of said resources in said pool based on said database access pattern and said resource relationship, wherein said plurality of resources in said pool can be accessed but do not have to be allocated until a processing of a request;
generating a consumption model to predict resource needs based on said resource relationships, a traffic pattern and an availability of said plurality of resources; and
upon receiving of a subsequent request for processing, using said consumption model to predict any resource needs so as to dynamically allocate, reallocate and release said plurality of resources in a cascading manner until a completion of said subsequent request.

18. The computer program product of claim 17, wherein upon determining that said plurality of resources are not sufficient, at least one additional resource is added and enabled from said resource pool.

19. The computer program product of claim 17, wherein other resources are enabled and added that have not been part of said resource pool and when no resource availability is found, an alert is generated so that a processing request cannot be performed due to resource availability.

20. The computer program product of claim 17, wherein a plurality of databases is used by said computing environment.
